(19) United States
(12) Patent Application Publication
(10) Pub. No.: US 2023/0164851 A1
(43) Pub. Date: May 25, 2023

(54) METHOD AND SYSTEM FOR RADIO ACCESS CHANNEL (RACH) OPERATION

(71) Applicant: Sterlite Technologies Limited, Gurugram (IN)

(72) Inventors: Nitin Kumar, Gurugram (IN); Manish Jamwal, Gurugram (IN); Rishi Nandwana, Gurugram (IN); Satyanshu Srivastava, Gurugram (IN)

(73) Assignee: Sterlite Technologies Limited, Gurugram (IN)

(21) Appl. No.: 17/705,252

(22) Filed: Mar. 25, 2022

(30) Foreign Application Priority Data
Nov. 21, 2021 (IN) 202111053486

(51) Int. Cl. H04W 74/08; H04W 24/10; H04B 17/318; H04W 52/10

(52) U.S. Cl. CPC H04W 74/0841; H04W 24/10; H04B 17/318; H04W 52/10

(57) ABSTRACT

The present disclosure provides a method and a system (100) for radio access channel (RACH) operation. The method of transmitting a Random-Access Channel (RACH) request over a channel by a user equipment (UE) (110) in a cell, comprises transmitting a subsequent RACH request by the UE (110) in the cell in case of failure to receive a Random-Access Response (RAR) by the UE (110) during an earlier RACH request within a predefined time period. The earlier RACH request is associated with an earlier power and the subsequent RACH request is associated with a subsequent power. The subsequent power is the sum of the earlier power and a predefined delta power, where the predefined delta power is based on Reference Signal Received Power (RSRP) measurement of the UE within the cell.

### TECHNICAL FIELD

The present disclosure relates generally to wireless communication, and more specifically, to Random Access Channel (RACH) optimization in a radio communication.

### BACKGROUND

Random Access Channel (RACH) procedure is used to synchronize a user equipment (UE) to a network (gNodeB (gNB)), that is, to achieve uplink synchronization between the UE and the gNB. Generally, the UE performs the RACH procedure, for example, but not limited to, in the cases of initial access or handover or when uplink synchronization is lost or beam failure recovery.

During the RACH procedure, the UE selects one of preambles (defined in the 3GPP consortium standard) and transmits the preamble with transmission power P1, calculated by open-loop power control, to the gNB. If the UE does not receive any Random Access Response (RAR) within a predefined time from the gNB, the UE retransmits the preamble with transmission power P1+Delta to the gNB. The delta (powerRampingStep) value may be defined as 0/2/4/6 dB in a cell. The UE, which is far from cell edge or for any other reason, may need to make more RACH reattempts before the UE gets the RAR. In case of several RACH reattempts within the predefined time, total transmission power (transmission power P1+n*Delta) becomes too high as well as time taken for uplink synchronization unexpectedly increases, which is undesirable for a smooth handshake.

Similarly, in case of multiple UEs in a cell, the aforesaid delta power (powerRampingStep) value remains the same for all the UEs in that particular cell. So, for example, in a macro-cell environment, cell edge UEs may have to send multiple RACH to receive the RAR if powerRampingStep value is set too small, or cell-centered UEs or near to cell UEs may have to send 2^{nd}/3^{rd} preamble with undesirable high power if powerRampingStep value is set too high, which will eventually increase interference. Given that, it is not a good approach to have a common delta power for all the UEs. Some of the prior art references are given below:

US20190350010A1 discloses a method of user equipment (UE) for random access operation in a wireless communication system. The method comprises receiving, from a base station (BS), random access channel (RACH) configuration information including RACH chunk information corresponding to at least one antenna beam including a beam identifier (ID), determining a RACH chunk based on the RACH configuration information received from the BS, transmitting, to the BS, a RACH preamble on the determined RACH chunk according to the RACH configuration information associated with the beam ID, and receiving, from the BS, a RACH response (RAR) corresponding to the transmitted RACH preamble and a downlink channel for a RAR transmission, wherein a random access-radio network temporary identification (RA-RNTI) is calculated based on an index of a slot and an index of the RACH chunk on which the RACH preamble is transmitted.

EP3697140A1 discloses a method for use in a wireless communication system. In accordance with one embodiment the method includes receiving—by the wireless device—a synchronization signals and physical broadcast channel (SS/PBCH) block; receiving a control order for transmission of a preamble; and determining a transmission power for the preamble based on: a power offset value associated with a channel state information reference signal (CSI-RS) and a received power value of the CSI-RS, in response to the wireless device configured with the CSI-RS; and a received power value of the SS/PBCH block and not based on the power offset value, in response to the wireless device not configured with CSI-RS. The method further includes transmitting the preamble based on the transmission power.

In a non-patent literature entitled, “Efficiency of Power Ramping During Random Access in LTE”, the authors examine the impact of power ramping, number of retransmission attempts, and limitations of the Physical Downlink Control Channel (PDCCH) on the performance of random access in LTE/LTE-A networks.

While the prior arts cover various solutions for the RACH procedure, however these solutions are not optimized and experience same drawbacks (as detailed above) due to multiple RACH reattempts and undesirable values of delta power (powerRampingStep), thus, may lead to high latency, higher call set up time, for example Additionally, accessibility procedure has multiple steps and needs a lot of time for the UE to connect with the network, which is more critical when supporting URLLC (Ultra-Reliable Low Latency Communications) services. In light of the above-stated discussion, there is a need to overcome the above stated disadvantages.

### OBJECT OF THE DISCLOSURE

A principal object of the present disclosure is to provide method and system for radio access channel (RACH) operation, that is, for RACH optimization in a radio communication.

Another object of the present disclosure is to introduce parameters to optimize and improve RACH operation and to overcome the issue related to delta power (powerRampingStep) while uplink synchronization between a user equipment (UE) and a network (gNodeB (gNB)), thereby improving accessibility procedure.

Another object of the present disclosure is to define separate delta power step for specific UEs to enhance RACH success rate.

Yet another object of the present disclosure is to define a coverage level (rsrpSSBthresRACH) for the UE and to define delta power value (delta value) by a step powerRampingStep2 based on the coverage level (RSRPssbthresRACH).

### SUMMARY

Accordingly, the present disclosure provides a method of transmitting a Random-Access Channel (RACH) request over a channel by a user equipment (UE) in a cell. The method includes transmitting a subsequent RACH request by the UE in the cell in case of failure to receive a Random-Access Response (RAR) by the UE during an earlier RACH request within a predefined time period. The earlier RACH request is associated with an earlier power and the subsequent RACH request is associated with a subsequent power. The subsequent power is the sum of the earlier power and a predefined delta power, wherein the predefined delta power is based on Reference Signal Received Power (RSRP) measurement of the UE within the cell.

The method includes comparing the RACH request of the UE with a predefined Reference Signal Receive Power threshold for RACH (rsrpSSBthresRACH), wherein the RACH request of the UE is associated with the Reference Signal Received Power (RSRP) measurement of the UE in the cell. The method further includes defining the predefined delta power as a first predefined delta power when the RACH request has less power than the predefined RSRP threshold for RACH and defining the predefined delta power as a second predefined delta power when the RACH request has more power than the predefined RSRP threshold for RACH. The predefined RSRP threshold for RACH defines a coverage level. Based on which it can be said that the UE is near an edge of the cell when the RACH request of the UE has less power than the predefined RSRP threshold for RACH and the UE is near a center of the cell when the RACH request of the UE has more power than the predefined RSRP threshold for RACH.

Accordingly, a system of transmitting a Random-Access Channel (RACH) request over a channel is disclosed. The system comprises a user equipment (UE) in a cell that is configured to transmit a subsequent RACH request in case of failure to receive a Random-Access Response (RAR) by the UE during an earlier RACH request within a predefined time period. The earlier RACH request is associated with an earlier power and the subsequent RACH request is associated with a subsequent power. The subsequent power is the sum of the earlier power and a predefined delta power, wherein the predefined delta power is based on Reference Signal Received Power (RSRP) measurement of the UE within the cell.

In an implementation, the UE selects one of preambles and transmits the preamble with a transmission power calculated by an open-loop power control, wherein the UE transmits the preamble at a different delta power value defined by the open-loop power control, wherein a second preamble of the UE is of more power than a first preamble of the UE.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 is a view illustrating uplink synchronization between a user equipment (UE) and a base station.

FIG. 2 is a view illustrating a sequence diagram for uplink synchronization between the UE and the base station.

FIG. 3 is a flowchart illustrating a method of transmission of Random Access Channel (RACH) request by the UE to the base station.

FIG. 4 illustrates various hardware elements of the UE.

FIG. 5 illustrates various hardware elements of the base station.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in details so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

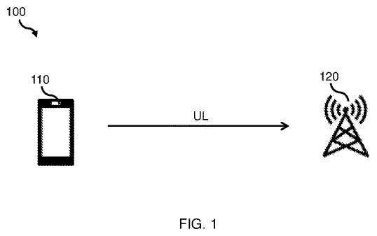

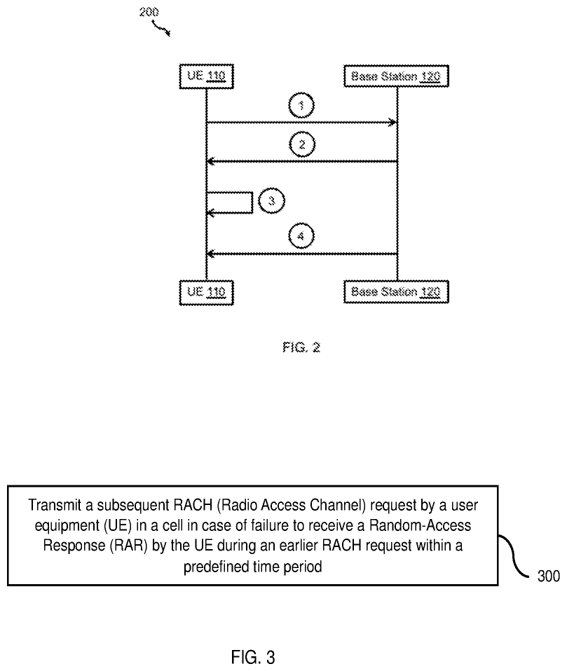

The following discussion makes simultaneous reference to FIG. 1 through FIG. 2, in which FIG. 1 is a view illustrating uplink synchronization between a user equipment (UE) and a base station in a wireless communication system 100 and FIG. 2 is a view illustrating a sequence diagram 200 for uplink synchronization between the UE and the base station.

The wireless communication system (interchangeably “system”) 100 comprises at least one user equipment (UE) (interchangeably “UE”) 110 and a base station 120. The at least one UE 110 may also be referred to as an access terminal (AT) or terminal, a mobile station (MS), a subscriber unit, or other appropriate term. The UE 110 may be a cellular phone, a personal digital assistant (PDA), a wireless modem, a wireless communication device, a handheld device, a laptop computer, a netbook, a cordless phone, a wireless local loop (WLL). The base station 120 is generally a fixed station that communicates with the at least one UE 110 and may also be called an access point, a Node B, gNodeB, or some other terminology. The base station 120 provides communication coverage for a particular geographic area. The term “cell” may refer to a base station and/or its coverage area depending on the context in which the term is used.

The at least one UE 110 may communicate with the base station 120 on the downlink and uplink. The downlink (or forward link) refers to the communication link from the base station to the UE, and the uplink (reverse link) refers to the communication link from the UE to the base station. The present disclosure intends to provide an optimized way of uplink communication/synchronization.

In order to establish communication i.e., uplink synchronization, the UE 110 residing in a cell may initiate a RACH procedure and transmit a RACH request to the base station 120 over a channel A RACH, in general, is a shared channel used by UEs to access mobile networks for call set-up and burst data transmission. Whenever a UE wants to make a mobile originating call it schedules the RACH. The UE 110 may perform the RACH procedure, for example, but not limited to, in the cases of initial access or handover or when uplink synchronization is lost or beam failure recovery.

During the RACH procedure, the UE 110 may select one of preambles (defined in the 3GPP consortium standard) and transmit the preamble with transmission power P1, calculated by open-loop power control, to the base station 120 over a channel (at step 1). The preamble may comprise a cyclic prefix (CP) and preamble sequence. The preamble may be selected from supported known formats such as Format 0, Format 1, Format 2, Format 3, Format A1, Format A2, Format A3, Format B1, Format B2, Format B3, Format B4, Format C0, Format C1. The open-loop power control may be a one directional control process having no feedback. That is, in the open-loop power control, a control path does not have any feedback input. The open-loop power control method may take in many inputs, but all of these inputs may be from the UE's internal setting or measurement data by the UE. There may be no feedback input from the base station 120.

If the UE 110 fails to receive a Random-Access Response (RAR) within a predefined time period during the earlier RACH request (as discussed above), a subsequent RACH request may be transmitted by the UE 110 to the base station 120 with a subsequent power. The subsequent power may be the sum of an earlier power (transmission power P1) associated with the earlier RACH request and a predefined delta power, wherein the predefined delta power may be based on Reference Signal Received Power (RSRP) measurement of the UE within the cell. The UE 110 may transmit the preamble at a different delta power value defined by the open loop power control.

In an implementation, once the UE 110 has sent the preamble with transmission power P1 to the base station 120, the base station 120 may transmit Reference Signal Receive Power (RSRP)=(rsrpSSBthresRACH) to the UE 110 (at step 2), where RSRP is the signal strength or signal level depicting coverage level at which the UE 110 should consider itself eligible to use a different power delta value which is defined by powerRampingStep2 (discussed below).

That is, once the UE 110 has sent the preamble with the transmission power P1, then that preamble-RACH request may be compared with a predefined RSRP threshold for RACH (rsrpSSBthresRACH), wherein the preamble-RACH request may be associated with the Reference Signal Received Power (RSRP) measurement of the UE 110 in the cell. Based on which, the powerRampingStep2 may define a delta power (thus called as the predefined delta power) (at step 3) as a first predefined delta power, when the preamble-RACH request (UE RACH) has less power than the predefined RSRP threshold for RACH and may define the predefined delta power as a second predefined delta power, when the preamble-RACH request (UE RACH) has more power than the predefined RSRP threshold for RACH. When the UE RACH has less power than the predefined RSRP threshold for RACH, it depicts that the UE 110 is near the edge of the cell. On the contrary, when the UE RACH has more power than the predefined RSRP threshold for RACH, it depicts that the UE 110 is near the center of the cell.

In short, based on a received threshold (i.e., predefined RSRP threshold for RACH (rsrpSSBthresRACH)=RSRP), the powerRampingStep2 defines power delta (delta power) as 0/2/4/6 dB in the cell. That is, a separate Delta power (powerRampingStep2) is defined for UEs, which means the UEs located on the cell edge will require more power compared to the UEs located near the cell center. Thereafter, the UE 110 may receive a Random-Access Response (RAR) (at step 4). In general, a RAR is a response/acknowledgement from the base station that it has properly received the preamble. The RAR is transmitted as a conventional downlink PDCCH/PDSCH (Physical Downlink Control Channel/Physical Data Shared Channel) transmission with the corresponding PDCCH transmitted within the common search space. The RAR includes index of the random-access preamble the base station detected and for which the response is valid, a timing correction calculated by the base station based on the preamble received timing, a scheduling grant, indicating what resource the device should use for the transmission of a subsequent message 3 and a temporary identity, TC-RNTI, is used for further communication between the UE and the base station. TC-RNTI (or Temporary Cell Radio Network Temporary Identifier) is a temporary ID inside MAC RAR, which is generated by the base station 120 as a response to the Random Access Preamble transmitted by the UE 110 as part of the RACH procedure.

By utilizing the above technique, the UE's second preamble may be of more power compared to the UE's first preamble.

Unlike conventional RACH management, the wireless communication system 100 implements an improved way of Random Access Channel (RACH) request transmission for uplink synchronization as disclosed above that advantageously increases system capacity and decreases call setup time. That is, the proposed solution reduces RACH time that helps to achieve the goal for low latency and thus increases system capacity. The proposed mechanism also supports ultra-reliable and low-latency communications (URLLC) services due to improved RACH performance.

In an aspect, the parameters powerRampingStep2 and rsrpSSBthresRACH may be introduced in SIB1 (System Information Block Type 1). In general, SIB1 is a cell-specific information i.e., only valid for a (serving) cell, which carries the critical information required for the UE to access the cell. SIB1 also includes information related to the availability and scheduling of other SIBs e.g., mapping of SIBs to System Information (SI) message, periodicity, SI-window size etc.

FIG. 3 is a flowchart 300 illustrating a method of transmission of Random Access Channel (RACH) request by the UE to the base station. It may be noted that in order to explain the method step(s) of the flowchart 300, references will be made to the elements explained in FIG. 1 and FIG. 2.

The method includes transmitting the subsequent RACH request by the UE 110 in the cell in case of failure to receive the RAR by the UE 110 during the earlier RACH request within the predefined time period. The earlier RACH request may be associated with the earlier power (transmission power P1) and the subsequent RACH request may be associated with the subsequent power, where the subsequent power may be the sum of the earlier power (transmission power P1) and the predefined delta power. The predefined delta power may be based on Reference Signal Received Power (RSRP) measurement of the UE within the cell.

It may be noted that the flowchart 300 is explained to have above stated process steps; however, those skilled in the art would appreciate that the flowchart 300 may have more/less number of process steps which may enable all the above stated implementations of the present disclosure.

The various actions, acts, blocks, steps, or the like in the flow chart may be performed in the order presented, in a different order or simultaneously. Further, in some implementations, some of the actions, acts, blocks, steps, or the like may be omitted, added, modified, skipped, or the like without departing from the scope of the invention.

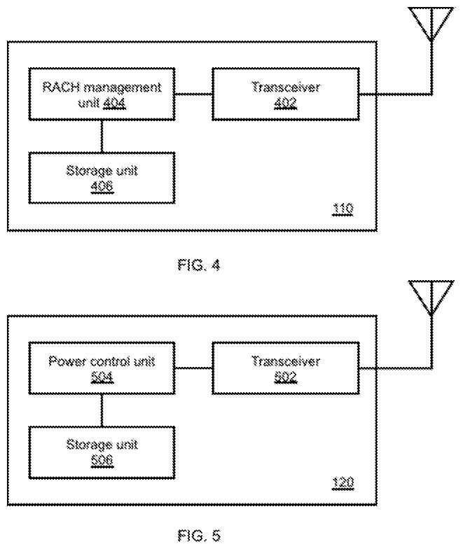

FIG. 4 illustrates various hardware elements of the UE 110, according to present disclosure.

Referring to FIG. 4, various hardware elements of the UE 110 may include a transceiver 402, at least one processor and/or RACH management unit 404, and a storage unit 406. However, the components of the UE 110 are not limited to the above-described example, and for example, the UE 110 may include more or fewer components than the illustrated components. In addition, the transceiver 402, the storage unit 406, and the RACH management unit 404 may be implemented in the form of a single chip.

The transceiver 402 may transmit and receive signals to and from the base station 120. Here, the signal may include control information and commands or other RACH related information. To this end, the transceiver 402 may include an RF (radio frequency) transmitter that upconverts and amplifies a frequency of a transmitted signal, and an RF receiver that amplifies a received signal with low noise and down converts a frequency. Alternatively, the RF transmitter and RF receiver, of the transceiver 402, may together be referred as a TRX radio module. However, this is only an example component of the transceiver 402, and components of the transceiver 402 are not limited to the RF transmitter and the RF receiver. In addition, the transceiver 402 may receive a signal through a wireless channel such as RACH, output the same to the RACH management unit 404, and transmit the signal output from the RACH management unit 404 through the wireless channel. In addition, the transceiver 402 may separately include an RF transceiver for an LTE system and an RF transceiver for an NR system, or may perform physical layer processing of LTE and NR with one transceiver.

The storage unit 406 may store programs and data necessary for the operation of the RACH management unit 404. In addition, the storage unit 406 may store control information or data included in signals transmitted and received by the UE 110. The storage unit 406 may be composed of a storage medium such as read only memory (ROM), random access memory (RAM), hard disk, compact disc ROM (CD-ROM), and digital versatile disc (DVD), or a combination of storage media. Also, there may be a plurality of storage units 406.

The RACH management unit 404 may control a series of processes so that the UE 110 may operate according to description described above. For example, the RACH management unit 404 may receive instructions, from the base station 120 indicating UL transmission power and apply the UL transmission power according to the instructions received from the base station 120. Basically, the RACH management unit 404 may perform all the functions of the UE 110, details of which are excluded herein for sake of brevity but should be understood and read in conjunction with FIG. 1 and FIG. 2. There may be a plurality of RACH management units 404, and the RACH management unit 404 may perform a component control operation of the UE 110 by executing a program stored in the storage unit 406.

FIG. 5 illustrates various hardware elements of the base station 120, according to present disclosure.

Referring to FIG. 5, various hardware elements of the base station 120 may include a transceiver 502, at least one processor and/or power control unit 504, and a storage unit 506. However, the components of the base station 120 are not limited to the above-described example, and for example, the base station 120 may include more or fewer components than the illustrated components. In addition, the transceiver 502, the storage unit 506, and the power control unit 504 may be implemented in the form of a single chip.

The transceiver 502 may transmit and receive signals to and from a terminal i.e., the UE 110. Here, the signal may include control information and data related to RACH, for example. To this end, the transceiver 502 may include an RF (radio frequency) transmitter that upconverts and amplifies a frequency of a transmitted signal, and an RF receiver that amplifies a received signal with low noise and down converts a frequency. Alternatively, the RF transmitter and RF receiver, of the transceiver 502, may together be referred as a TRX radio module. However, this is only an example component of the transceiver 502, and components of the transceiver 502 are not limited to the RF transmitter and the RF receiver. In addition, the transceiver 502 may receive a signal through a wireless channel, output the same to the power control unit 504, and transmit the signal output from the power control unit 504 through a wireless channel. In addition, the transceiver 502 may separately include an RF transceiver for an LTE system and an RF transceiver for an NR (New Radio) system, or may perform physical layer processing of LTE and NR with one transceiver.

The storage unit 506 may store programs and data necessary for the operation of the power control unit 504 of the base station 120. In addition, the storage unit 506 may store control information or data included in signals transmitted and received by the base station 120. The storage unit 506 may be composed of a storage medium such as read only memory (ROM), random access memory (RAM), hard disk, compact disc ROM (CD-ROM), and digital versatile disc (DVD), or a combination of storage media. Also, there may be a plurality of storage units 506.

The power control unit 504 may control a series of processes so that the base station 120 can operate according to description described above. For example, the power control unit 504 may transmit Reference Signal Receive Power (RSRP)=(rsrpSSBthresRACH) to the UE 110, where RSRP is the signal strength or signal level depicting coverage level at which the UE 110 should consider itself eligible to use a different power delta value which is defined by powerRampingStep2. Basically, the power control unit 504 may perform all the functions of the base station 120, details of which are excluded herein for sake of brevity but should be understood and read in conjunction with FIG. 1 and FIG. 2. There may be a plurality of power control units 504, and the power control unit 504 may perform a component control operation of the base station 120 by executing a program stored in the storage unit 506.

The embodiments/aspects disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey those certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method of transmitting a Random-Access Channel (RACH) request over a channel by a user equipment (UE) (110) in a cell, comprising:
transmitting a subsequent RACH request by the UE (110) in the cell in case of failure to receive a Random-Access Response (RAR) by the UE (110) during an earlier RACH request within a predefined time period,
wherein the earlier RACH request is associated with an earlier power and the subsequent RACH request is associated with a subsequent power,
wherein the subsequent power is the sum of the earlier power and a predefined delta power, the predefined delta power is based on Reference Signal Received Power (RSRP) measurement of the UE within the cell.

2. The method as claimed in claim 1 further comprising:
comparing the RACH request of the UE (110) with a predefined Reference Signal Receive Power threshold for RACH (rsrpSSBthresRACH), wherein the RACH request of the UE (110) is associated with the Reference Signal Received Power (RSRP) measurement of the UE (110) in the cell;
defining the predefined delta power as a first predefined delta power when the RACH request has less power than the predefined RSRP threshold for RACH; and
defining the predefined delta power as a second predefined delta power when the RACH request has more power than the predefined RSRP threshold for RACH.

3. The method as claimed in claim 2, wherein the UE (110) is near an edge of the cell when the RACH request of the UE (110) has less power than the predefined RSRP threshold for RACH and the UE (110) is near a center of the cell when the RACH request of the UE (110) has more power than the predefined RSRP threshold for RACH.

4. The method as claimed in claim 1, wherein the UE (110) selects one of preambles and transmits the preamble with a transmission power calculated by an open-loop power control, wherein the UE (110) transmits the preamble at a different delta power value defined by the open-loop power control, wherein a second preamble of the UE (110) is of more power than a first preamble of the UE (110).

5. The method as claimed in claim 1, wherein the predefined RSRP threshold for RACH defines a coverage level.

6. A system (100) of transmitting a Random-Access Channel (RACH) request over a channel, comprising:
a user equipment (UE) (110) in a cell configured to transmit a subsequent RACH request in case of failure to receive a Random-Access Response (RAR) by the UE (110) during an earlier RACH request within a predefined time period,
wherein the earlier RACH request is associated with an earlier power and the subsequent RACH request is associated with a subsequent power,
wherein the subsequent power is the sum of the earlier power and a predefined delta power, the predefined delta power is based on Reference Signal Received Power (RSRP) measurement of the UE within the cell.

7. The system (100) as claimed in claim 6 configured to:
compare the RACH request of the UE (110) with a predefined Reference Signal Receive Power threshold for RACH (rsrpSSBthresRACH), wherein the RACH request of the UE (110) is associated with the Reference Signal Received Power (RSRP) measurement of the UE (110) in the cell;
define the predefined delta power as a first predefined delta power when the RACH request has less power than the predefined RSRP threshold for RACH; and
define the predefined delta power as a second predefined delta power when the RACH request has more power than the predefined RSRP threshold for RACH.

8. The system (100) as claimed in claim 7, wherein the UE (110) is near an edge of the cell when the RACH request of the UE (110) has less power than the predefined RSRP threshold for RACH and the UE (110) is near a center of the cell when the RACH request of the UE (110) has more power than the predefined RSRP threshold for RACH.

9. The system (100) as claimed in claim 6, wherein the UE (110) selects one of preambles and transmits the preamble with a transmission power calculated by an open-loop power control, wherein the UE (110) transmits the preamble at a different delta power value defined by the open-loop power control, wherein a second preamble of the UE (110) is of more power than a first preamble of the UE (110).

10. The system (100) as claimed in claim 6, wherein the predefined RSRP threshold for RACH defines a coverage level.
